(19) United States
(12) Patent Application Publication
(10) Pub. No.: US 2008/0102966 A1
(43) Pub. Date: May 1, 2008

(54) Spherical Universal Coupling

(75) Inventor: Keith E. Gleasman, Fairport, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: TORVEC, INC., Pittsford, NY (US)

(21) Appl. No.: 11/553,736

(22) Filed: Oct. 27, 2006

(51) Int. Cl. F16D 3/00

(52) U.S. Cl. 464/125

(57) ABSTRACT

A pair of spherical gears connects the intersecting shafts of a CV-joint. One gear has internal teeth, and the other has external teeth. The gear design is based on pitch circles that are great circles on theoretical pitch spheres that are concentric and have identical radii. The gear teeth are preferably straight-sided. Individual smaller construction spheres are arranged in a circle so that the points of tangency between successive smaller spheres are all positioned on the circumference of the identical pitch circles of the gears and are all also positioned on the respective pitch circles of each successive smaller construction sphere. The straight-sided tooth faces of the teeth of the internal gear are preferably cone shaped. The preferred embodiment uses six teeth on each gear, and the gears, while rotating at high speeds under load, can intersect throughout a continuous maximum range of 60° or more.

### BACKGROUND OF THE INVENTION

1. Field of the Invention

The invention relates to universal couplings and automotive half-shafts, and more particularly, to constant-velocity universal joints for directly connecting two shafts in a manner that transmits rotation from the driving shaft to the driven shaft while, at the same time, permitting the angle of intersection between the axes of the shafts to be varied away from 180° alignment in any direction over a relatively wide and continuous range of angles (e.g., 60° or more).

2. Description of Related Art

There are well known non-gear means for transmitting rotary motion between shafts experiencing angular change. Perhaps the best known of such devices are the universal joints used to connect the drive shafts and wheel axles of automotive vehicles. Such universal joints are often constructed in the venerable double-yoke (Cardan) form of two small intersecting axles interconnected by a pair of yokes. However, the shafts connected by such yoke and axle joints do not turn at the same rate of rotation throughout each entire revolution. Therefore, constant velocity (“CV”) joints have been developed (e.g., Rzeppa and Birfield) in which the points of connection between the angled shafts are provided by sliding balls which, during each revolution of the driving and driven shafts, slide back and forth in individual tracks to maintain their respective centers at all times in a plane which bisects the instantaneous angle formed between the shafts. However, such universal and CV-joints are quite complex and relatively difficult to lubricate, and the design and manufacture of such joint components is widely recognized as a very specialized and esoteric art of critical importance to the worldwide automotive industry. While this universal joint art is very well developed, the joints are expensive, including many parts that are difficult and expensive to manufacture due to large surface areas that must be ground with extreme accuracy (e.g., 0.0002″/0.005 mm). Such joints are limited in regard to the rotational speeds that they can transmit and, more particularly, in regard to the size of the angles over which they can operate efficiently because of the point contact and significant amount of sliding of the balls.

Fairly recently, a universal coupling using a new type of “spherical” gearing (invented by Vernon E. Gleasman) was disclosed in U.S. Pat. No. 5,613,914. That patent, and its many corresponding patents throughout the world, disclosed spherical gears having several different possible tooth forms that could be incorporated into various designs of disclosed CV-joints. This spherical gearing is based on a radically different gear geometry design. Namely, the use of a single pair of gears to transmit constant velocity between two shafts is accomplished by a design in which one of the gears has internal teeth and the other has external teeth, and the pitch circles of the two gears are of identical size and always remain, in effect, as great circles on the same pitch sphere. As is axiomatic in spherical geometry, such great circles intersect at two points, and the pair of lunes formed on the surface of the sphere between the intersecting great circles (i.e., between the pitch circles of the two gears) inscribe a giant lemniscate (“figure-eight”) around the surface of the sphere. Since the relative movement of the tooth contact points shared between the mating gears inscribe respective lemniscates at all relative angular adjustments of the gear shafts, the two shafts rotate at constant velocity.

Although the pitch circles of each spherical gear have just been indicated to be theoretical great circles on the same pitch sphere, the just-cited patent realizes that each gear of the pair must, of course, have its own respective theoretical pitch surface in order to account for relative motion between the gears. Thus, each spherical gear should also be thought of theoretically as having its own respective pitch surface in the form of a respective one of a pair of respective pitch spheres that have coincident centers and radii which are substantially identical while permitting each pitch sphere to rotate about its respective axis. Therefore, each pitch circle can also be considered theoretically to be, respectively, a great circle on a respective one of these substantially identical pitch spheres so that the pitch circles of the gear pair effectively intersect with each other at two points separated by 180° (i.e., “poles”), and the axes of rotation of the two respective pitch spheres intersect at the coincident centers of the two pitch spheres at all times and at all angles of intersection.

This just-described spherical gearing was built and bench tested, clearly indicating that such spherical-gear joints efficiently provide true constant velocity with low friction for angular connections when operating at high speeds while the angles between the shafts are continuously varying through much larger angles than standard commercial automotive CV-joints. Thereafter, further testing and design has resulted in the improvements disclosed herein, providing lighter but stronger joints that can carry heavier loads while being easier and cheaper to manufacture.

Universal joints are presently used in the forms of (a) interlocking yokes (e.g., Cardan joints) to provide angular interconnections in the drive shafts of vehicles and (b) automotive half-shaft drive axles to connect the output shafts of drive differentials with the turning and bouncing drive wheels of a vehicle. A typical commercial half-shaft includes two different types of universal joints, e.g., a Rzeppa universal joint at one end and a tri-pot universal joint at the other end. Each of these joints is complex and expensive to manufacture, e.g., the Rzeppa universal joint uses six precision ground balls that run back and forth in six respective precision ground tracks, and the tri-pot universal joint uses three precision ground spherical rollers and straight ground tracks. The invention herein discloses a much simpler and less expensive half-shaft.

### SUMMARY OF THE INVENTION

The invention uses a pair of spherical gears that function as a true constant-velocity (“CV”) joint to connect the intersecting shafts of a vehicle drive shaft. One gear has internal teeth, and the other has external teeth. The construction design of the individual teeth of the spherical gears of the invention differs in several respects from that disclosed in above-cited U.S. Pat. No. 5,613,914. The invention adheres to the basic spherical gear concepts disclosed in this prior art, namely: (1) using pitch circles that are great circles on theoretical pitch spheres that are concentric and have identical radii, and (2) using teeth that are straight-sided. However, the geometric construction of the invention uses an additional plurality of individual smaller construction spheres arranged in a circle so that the points of tangency between successive smaller spheres are (a) all positioned on the circumference of the identical pitch circles of the gears, and (b) are all also positioned on the respective pitch circles of each successive smaller construction sphere, in the manner disclosed in greater detail below.

The straight-sided tooth faces of the teeth of the internal gear are cone shaped, the dimensions of each cone face being constructed tangent to the pitch circle of its respective smaller construction sphere. Each straight-sided tooth face of the teeth of the external gear has (i) a cylindrical central portion with a radius equal to one-half the normal circular thickness of its respective individual smaller construction sphere, and (ii) two respective flat face extensions that extend tangent from the central portion in accordance with a predetermined maximum angle of the continuum of angles through which the gears are desired to intersect. The preferred embodiment uses only six teeth on each gear, and the gears, while rotating at high speeds under load, can intersect throughout a continuous maximum range of 60° or more. [NOTE: Persons skilled in this art will immediately appreciate that, by placing two of the spherical-gear joints disclosed herein back-to-back (like a double Cardan universal joint), constant velocity rotational motion can be transmitted by shafts intersecting throughout a continuous maximum range of 120° or more.]

In one embodiment, the invention's spherical-gear CV-joints are incorporated in an automotive half-shaft along with a small plunge adaptor on the shaft end of one of the joints. In comparison with present commercial automotive half-shafts, the half-shaft disclosed herein is (a) smaller and lighter, (b) simpler and easier to assemble, (c) much less expensive to manufacture, and (d) significantly reduces the number of replacement parts to be inventoried.

### BRIEF DESCRIPTION OF THE DRAWINGS

FIG. 1 is a schematic and partially cross-sectional view of a spherical-gear CV-joint according to the invention with the respective axle shafts shown with their axes in 180° alignment.

FIG. 2 is a second view of the CV-joint of FIG. 1 showing the respective axle shafts intersecting at a predetermined maximum angle x° away from 180° alignment (the drawing showing the shafts intersecting at 30°) thereby providing angular movement through out an overall continuum of 2x° in all directions (60°).

FIGS. 3A, 3B, and 3C illustrate schematically the relative motion between sets of tooth contact points on the theoretical spherical pitch surfaces of a pair of rotating spherical gears arranged in the manner generally indicated in FIG. 2.

FIG. 4 is a graphic-type representation of the relative motion between one of the sets of tooth contact points illustrated in FIGS. 3A, 3B, and 3C.

FIGS. 5A, 5B, 5C, and 5D show geometric constructions for determining the tooth shapes for a pair of spherical gears according to the invention, with FIG. 5C being enlarged for clarity to show a more detailed construction of one tooth face of an external gear, and with FIG. 5D being a combination of a geometric construction with a schematic partial cross-sectional view of a portion of a pair of gears using such tooth designs.

FIGS. 6A and 6B are perspective views of designs, respectively, of the internal and external gears of a spherical pair according to a variation of the embodiment of the invention illustrated in FIGS. 1 and 2.

FIG. 7 is an exploded view of a preferred design of the invention's CV-joint.

FIG. 8 is a chart representing the positions of the line contact shared by the meshing teeth of the spherical gears in a CV-joint according to the invention, showing the relative positions of the line of contact on each of two meshing tooth faces at various angles of intersection between the axes of the axles, the shape of the tooth faces being flattened onto the surface of the drawing and slightly exaggerated to facilitate perception.

FIGS. 9A and 9B are two views of a preferred CV-joint taken from the opposite poles of the spherical gears at the same moment in time during meshing engagement, the cup support for the teeth of the internal gear being omitted for clarity.

FIG. 10 is a schematic representation of a universal joint using only CV-joints according the invention.

FIG. 11 is a schematic representation of a half-shaft with CV-joints according to the invention at each end in combination with a plunge-unit slider.

FIGS. 12A and 12B are side views of the plunge-unit slider shown positioned between the inventive CV-joints on the half-shaft in FIG. 11, FIG. 12B being a cross section taken along the plane 12B-12B of FIG. 12A.

### DETAILED DESCRIPTION OF THE INVENTION

### Spherical Gear System

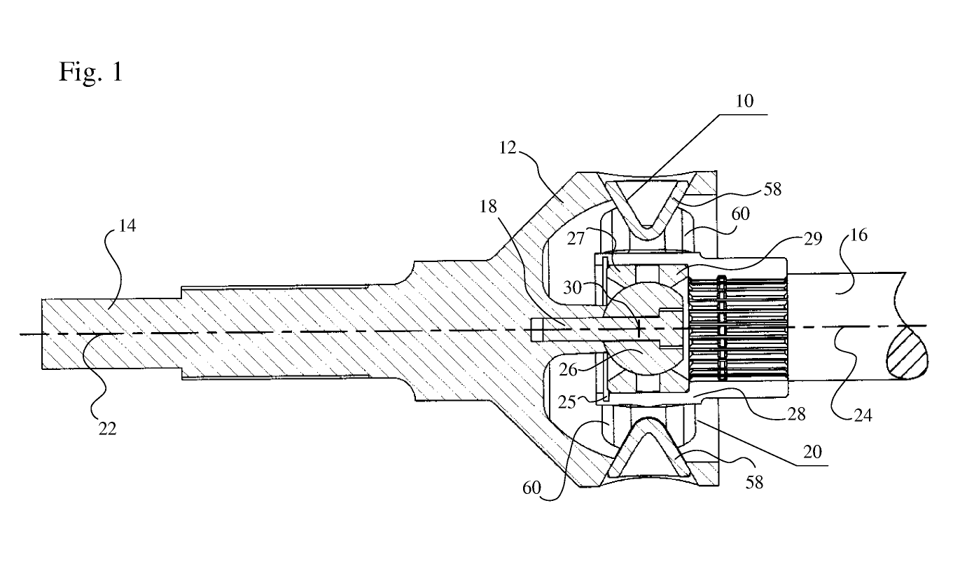

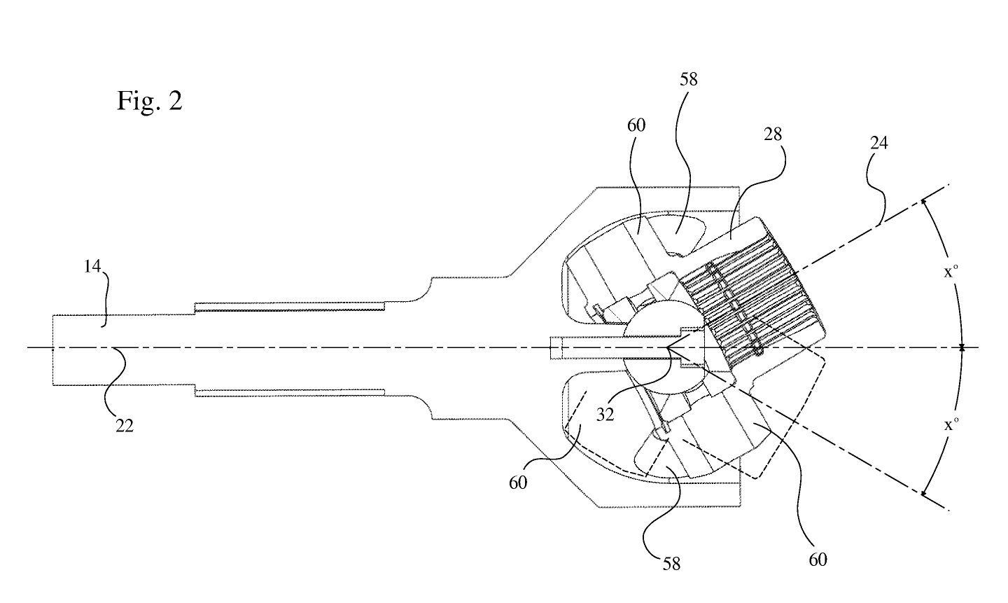

FIG. 1 and FIG. 2 illustrate a constant-velocity universal joint using spherical gears for interconnecting a pair of rotating shafts. FIG. 1 is a schematic and partially cross-sectional view of an internal gear 10 (with internal teeth 58) fixed within a cup-like support 12 having one end fixed to a first shaft 14. A mating external gear 20 (with external teeth 60) is fixed for rotation to a second shaft 16. In FIG. 1, shafts 14 and 16 are shown with their respective axes 22, 24 positioned in 180° alignment. Axes 22, 24 are also the respective axes of mating spherical gears 10, 20.

A spherical bearing maintains the mating gears 10 and 20 in proper meshing relationship. This spherical bearing includes (a) an interior member, preferably a centering ball 26, fixed to the base of cup-like support 12 by bolt 18, and (b) an exterior member in the form of a hub 28 formed on the interior of gear 20. The latter includes two spherical rings 27 and 29 that capture centering ball 26 and are held within hub 28 by a C-clip 25. The center point 30 of the identical theoretical pitch spheres of each gear 10, 20 is indicated within interior member 26 of the spherical bearing, and the axes 22, 24 each pass through center point 30.

FIG. 2 shows the same spherical gear arrangement shown in FIG. 1 with shaft 16 omitted. However, in FIG. 2 the axes 22, 24 of shafts 14 and 16, respectively, are shown intersecting at x°, namely, at some predetermined maximum shaft angle x° up to which the shaft axes may variably intersect while rotational forces are being transmitted. In the embodiment illustrated in FIG. 2, the predetermined maximum shaft angle x° is 30° from 180° alignment and, therefore, the illustrated spherical gear pair is designed to transmit rotational forces throughout a continuous range of angular intersection between the shafts up to 2x° in all directions (i.e., in this preferred embodiment throughout a range up to 60°).

The external teeth 60 of gear 20 are shown in solid lines pivoted about a pivot axis 32 that passes through center point 30 (see FIG. 1) at the intersection of axes 22, 24. Gear 20 is pivoted relative to gear 10 at an angle x° (30° in this embodiment) in a first direction, and an external tooth 60 of gear 20 is also shown in phantom lines pivoted about axis 32 at an angle x° in the opposite direction, providing a full range of motion of 2x° (60° in this embodiment) in all directions.

This illustrates the wide angular range of intersection through which the gear pair may be variably pivoted while rotational forces are being satisfactorily transmitted. At all times during such variable angular relative motion between the shaft axes, gears 10 and 20 remain in mesh at two respective meshing areas, the center of each meshing area being located at one of the two respective points at which the gears' pitch circles intersect with pivot axis 32, as will be explained further below.

In the CV-joint arrangement shown in FIGS. 1 and 2, spherical gears 10, 20 function in a manner similar to known gear couplings in that they do not rotate relative to each other as their respective shafts rotate at a 1:1 ratio. However, whenever the angular orientation of their respective shafts is variably adjusted out of 180° alignment (as shown in FIG. 2), the teeth of the gears continuously move into and out of mesh at two respective meshing points even though the gears rotate at all times at the same speed. This will also be explained further below.

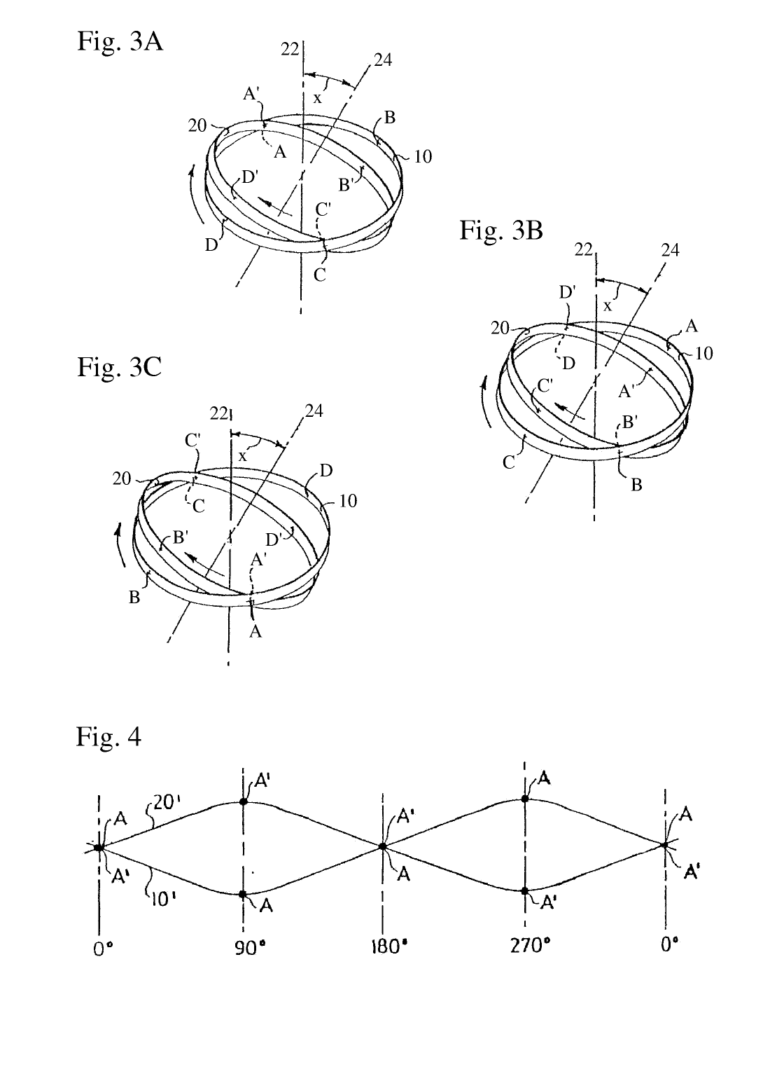

This relative movement of the teeth of gears 10, 20, into and out of mesh, is shown schematically in FIGS. 3A, 3B, and 3C which represent, respectively, three different positions of relative gear rotation about axes 22, 24 when axes 22, 24 are intersecting at a predetermined maximum angle of x°. FIGS. 3A, 3B, and 3C show the relative advancement of four different respective sets of tooth contact points as the mating gear teeth move into and out of mesh.

In FIG. 3A, a tooth contact point A on internal gear 10 is in mesh with tooth contact point A′ on external gear 20; simultaneously, a tooth contact point C on internal gear 10 is in mesh with a tooth contact point C′ on external gear 20. FIG. 3B shows the same tooth contact points on each gear after the gears have rotated at 1:1 for a quarter of a rotation, the gear tooth contact points D and B of gear 10 and points D′ and B′ of gear 20 now being in meshing contact. Following a further quarter turn, as shown in FIG. 3C, tooth contact points A, A′ and C, C′ once again mesh, but at a relative position 180° from their initial contact position shown in FIG. 3A.

The tooth contact points represented in FIGS. 3A, 3B, and 3C are all located on the pitch circles of their respective gears; and these pitch circles are each great circles on, in theoretical effect, the same sphere (see Background above). Geometrically, all great circles intersect each other at two positions 180° apart. In describing the motion of spherical gears, these intersection points are referred to as “poles”. FIG. 4 is a schematic and graphic representation of the relative motion between one of the respective sets of tooth contact points illustrated in FIGS. 3A, 3B, and 3C. Namely, FIG. 4 traces the movement of tooth contact points A, A′ along their respective pitch circles 10′, 20′ as gears 10, 20 make one full revolution together. Although the respective pitch circles are shown in flat projection, it can be seen that each tooth contact point traces a lemniscate-like pattern (a “figure-eight on the surface of a sphere”); as is well known in the universal joint art, such lemniscate motion is essential when transferring constant velocity between two articulated shafts.

### Design of Spherical Gear Teeth

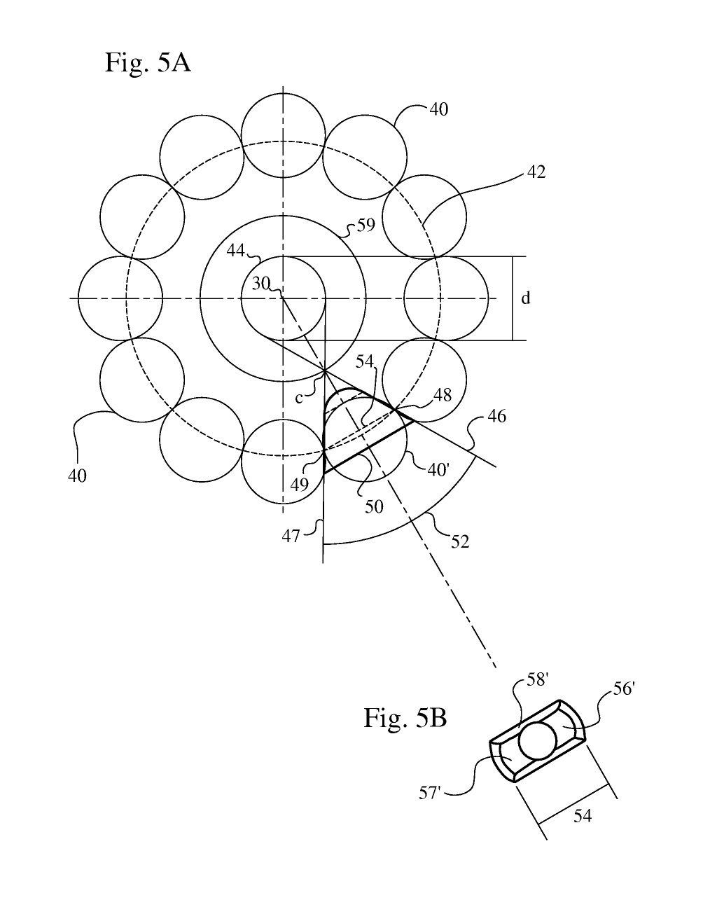

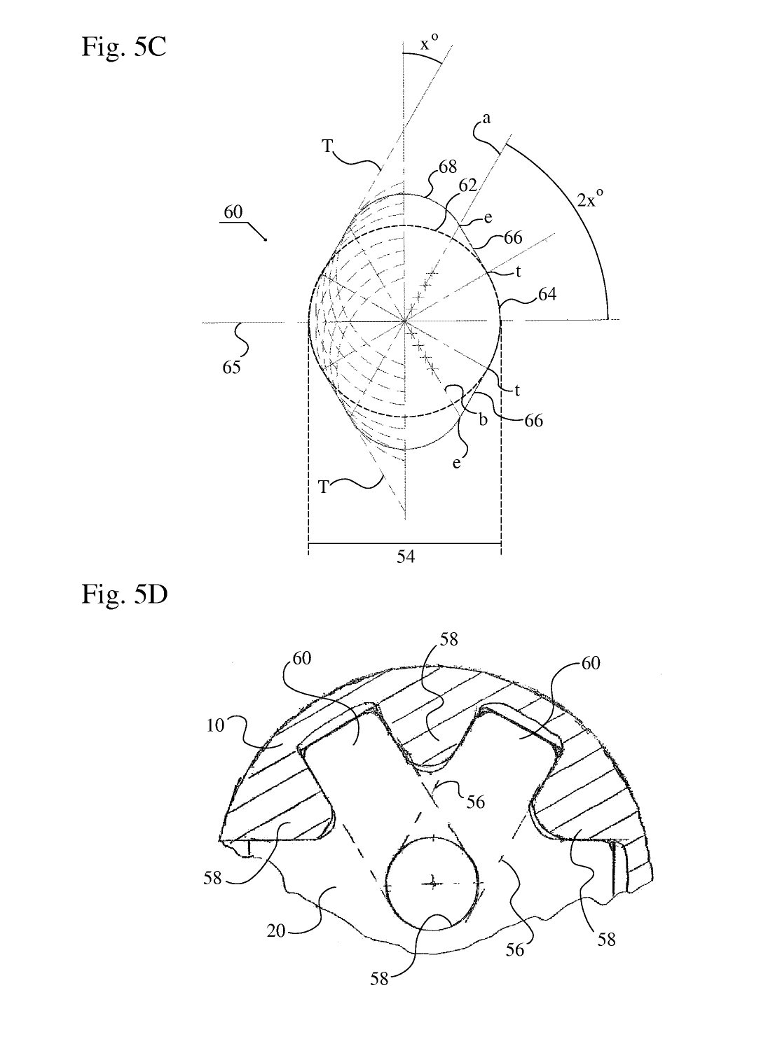

While there are other ways to determine the design parameters of gear teeth appropriate for this spherical gear system (see Background above), for the invention herein such design is preferably done by the following geometric construction illustrated in FIGS. 5A, 5B, 5C, and 5D:

(1) The first step in the design of spherical gear teeth disclosed herein is approached in the same manner as is well known in the gearing art. Namely, size and strength specifications for the gear pair are determined in accordance with the application expected to be performed by the gears. For instance, the preferred CV-joint gears disclosed herein are designed for use in the steering/drive axle of an automotive light truck. The addendum circle (maximum diameter) of the gears is usually limited by the physical space in which the gearing must operate, and the diametral pitch must be selected so that the chordal thickness of the teeth (i.e., the chordal thickness of each tooth along the pitch circle) is sufficient to permit the maximum expected load to be carried by the teeth in mesh.

In this regard, it is essential to remember that when using a pair of spherical gears according to this invention to transmit motion, the gears are capable of handling twice the load as a conventional pair of gears of the same size. That is, since the gear pair shares two meshing areas (pole areas) centered 180° apart, it has twice as many teeth in mesh as would a conventional gear pair of the same size.

(2) In addition to the concentric pitch spheres for each gear as indicated above, the invention uses a plurality of individual smaller construction spheres. The number of smaller construction spheres is selected in accordance with the total number of teeth desired in the final gear pair, and the smaller construction spheres are arranged in a circle so that the points of tangency between successive smaller spheres are all positioned on the circumference of the identical pitch circles of the gears. This condition dictates the parameters of the first construction shown in FIG. 5A.

In a preferred design of the invention, each gear is designed to have only six teeth so that, when the axes of the spherical gears are aligned at 180°, all twelve of the teeth are in full mesh. Therefore, for the construction of this preferred design, twelve small identical spheres 40 are arranged in a circle about center 30 of the predetermined identical theoretical pitch circles 42 of the two gears. The diameter d of the spheres is selected so that the spheres are tangent to each other along the predetermined identical theoretical pitch circles 42 of the two gears. (As indicated above, the pitch circle of each gear is a great circle on the identical pitch spheres of the gears which are sized to fit within the limited physical space in which the gearing must operate.) Each smaller sphere 40 represents one gear tooth, and the twelve small spheres represent all twelve of the teeth in full mesh when the gear axes are at 180°.

(3) The construct includes an additional small central sphere 44 positioned at the coincident centers of pitch circles 42, small central sphere 44 being the same size as small spheres 40.

(4) A construction involving central sphere 44 and a selected one of the small spheres 40 is used to determine the vertex angle for the conical surfaces of the cone-shaped tooth faces of each straight-sided tooth of the internal gear. Two crossing lines 46, 47 are constructed tangent to opposite sides of central sphere 44, each respective tangent line 46, 47 passing through a respective one of the two points of tangency that selected sphere 40 shares with its neighboring spheres. Namely, line 46 passes through tangent point 48 and line 47 passes through tangent point 49. A cone construct 50 is shown in heavy solid lines in FIG. 5A, and cone construct 50 is used to determine the vertex angle 52 of the conical surfaces of the tooth faces 56′, 57′ of an interior tooth 58′ shown in a top view in FIG. 5B. The size of cone vertex angle 52 is determined by the included angle formed at the point of intersection c of crossing lines 46, 47. In the preferred embodiment of the invention shown in FIGS. 1 and 2, this construction provides a cone vertex angle of 60°.

(5) The same construction shown in FIG. 5A is used to determine the normal chordal thickness 54 of each gear tooth. In the construction, normal chordal thickness 54 is measured on each selected smaller sphere 40 at the pitch line of its respective gear, i.e., between each of the two respective points of tangency that one selected sphere 40 shares with its neighboring spheres. This normal chordal thickness 54 is also indicated on internal tooth 58′ in FIG. 5B and (in larger scale) on external tooth 60 in FIG. 5C.

(6) The construction shown in FIG. 5A is also used to determine the maximum size of centering ball 26 that is the interior spherical bearing member shared by gear pair 10, 20 (see FIGS. 1 and 2). Reference is again made to the two crossing lines 46, 47 constructed tangent to opposite sides of central sphere 44 and used to determine the vertex angle of the cone-shaped faces of the interior gear teeth. Lines 46, 47 intersect at point c, and the distance between point c and center 30 determines the radius of circle 59. Circle 59 provides the maximum circumference for centering ball 26.

(7) The construct of each tooth 60 of the external gear of the spherical pair is shown enlarged in FIG. 5C, with the tooth 60 per se appearing in heavy solid lines:

The surface of a cylinder 62 provides the central portion 64 of each of the two faces of tooth 60. Cylinder 62 has a radius that is one-half of the normal circular thickness that forms normal chordal thickness 54 measured on smaller sphere 40. From each side of cylindrical central portion 64, each external tooth face includes a flat face extension 66 that varies in accordance with the predetermined maximum angle x° (the maximum angle of intersection between the axes of the gears through which the gear pair is expected to operate), and in the construction illustrated the predetermined maximum angle is 30°. There are, of course, two flat face extensions 66, one on each side of cylindrical central portion 64.

Each flat face extension 66 begins at a respective initial tangent point t located x° from the center line 65 of its respective tooth face and extends to a point e intersecting a radial line of cylindrical central portion 62 measuring 2x°, so that the length t-e of each flat portion extends an additional x° beyond the initial tangent point t. Although flat face tangent extensions 66 can be further extended (as shown in broken lines), the x° length of each flat face extension 66 is sufficient to assure full line contact when the axes of the gears are intersecting at the maximum predetermined angle. Preferably, as shown in FIG. 5C, each respective outboard end of flat face extension 66 is discontinued at some predetermined short distance beyond point e that demarks the just-described x° length. Each of the just-described tooth faces of external tooth 60 intersects with two respective tooth end surfaces 68 that may be flat or slightly rounded as shown.

(8) The construction for developing each tangential flat extension of one working face of an external tooth is shown in the left-hand portion of FIG. 5C:

As can be appreciated from a review of FIGS. 3A, 3B, and 3C, when the circular orbit of gear 20 is tipped at an angle in any direction away from the plane of the circular orbit of internal gear 10, the circular orbit of the external teeth appears elliptical when viewed from the plane of gear 10. Also, when viewed perpendicularly from the plane of gear 10, the outer cardinal points become misaligned (e.g., in FIG. 3A: while points A, A′ and C, C′ are in mesh at the poles, points B′ and D′ fall inside points B and D when viewed perpendicularly from points B and D). Therefore, whenever the angle of intersection between the axes of the gears deviates from 180°, the pitch circle of external gear 20 effectively becomes an “elliptic arc” relative to the circular arc of the pitch circle of internal gear 10.

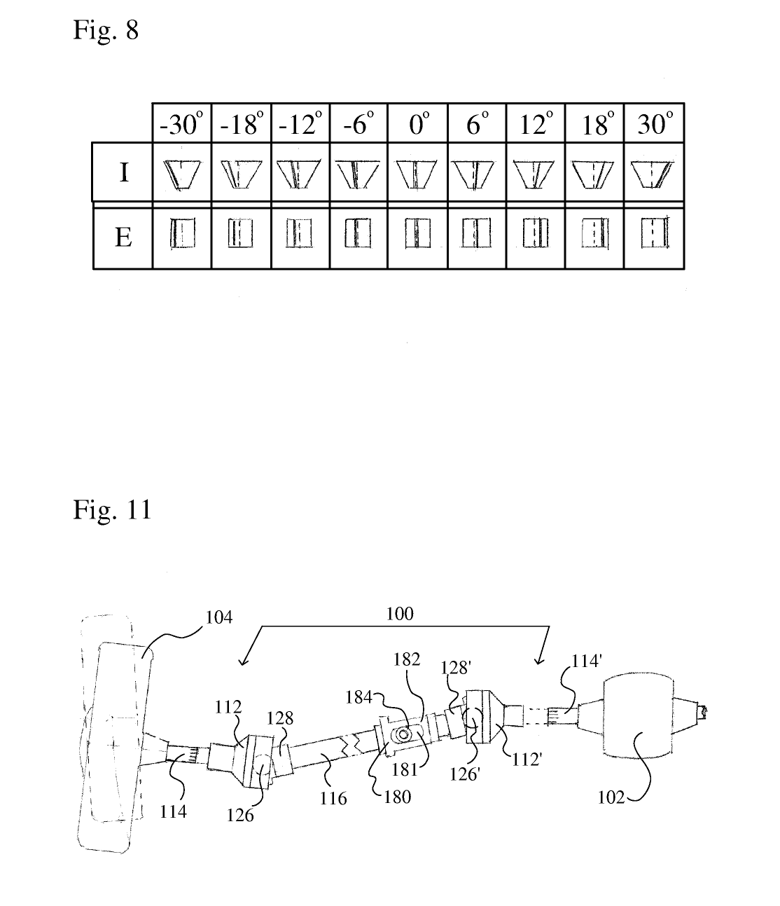

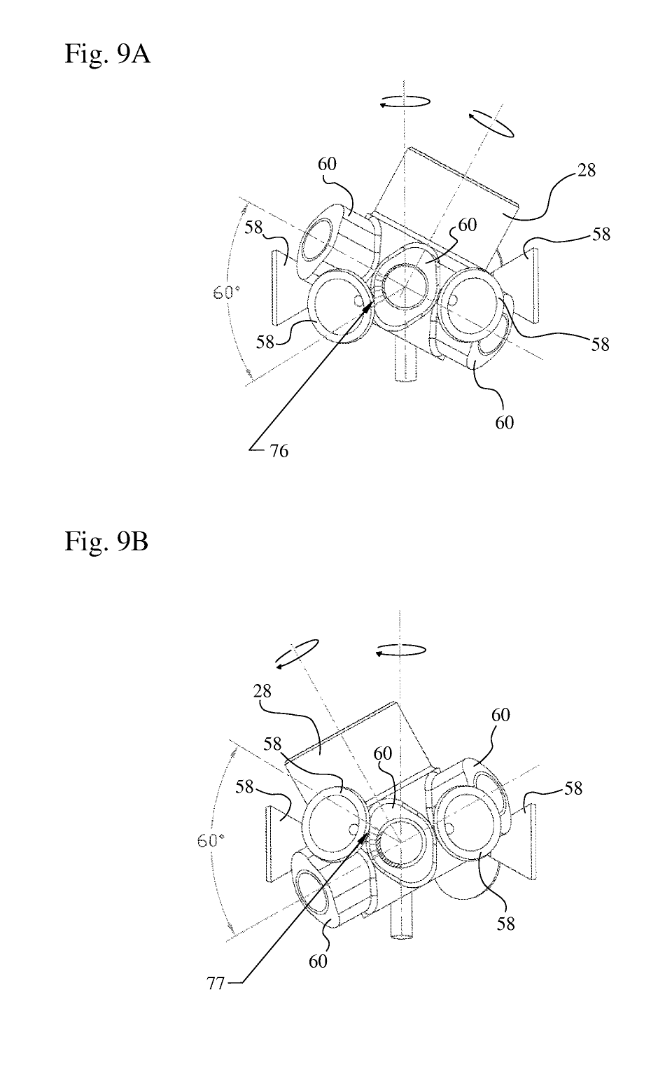

As will be explained in further detail below with reference to FIGS. 8, 9A, and 9B, when the external teeth roll into mesh with the internal teeth, they approach along the elliptic arc from either above or below the plane of the internal gear, and as the external teeth roll out of mesh, they leave mesh in the opposite direction. If the external teeth roll in from below the plane, they roll out above the plane. The distance the external teeth move above and below the plane of the internal gear is a function of the size of the angle of intersection between the great circle pitch circles of the gears.

As an external tooth approaches mesh along the elliptic from below the plane of the internal gear, tooth contact occurs on one side of each tooth face at one pole, and similar tooth contact occurs on the other side of the same tooth face when the same exterior tooth approaches mesh along the elliptic from above the plane of the internal gear. For purposes of the construction of FIG. 5C, it is assumed that the elliptic arc is at the maximum preferred angle x° (30°). The portion of the path of the elliptic arc approaching from below the plane of internal gear 10 is indicated by line a, while the portion of the path of the elliptic arc approaching from above the plane of internal gear 10 is indicated by line b.

In this construction, the center of cylinder 62 (that forms the central portion 64 of the tooth face) is moved along approach line a to form a plurality of additional circular arcs (only four such arcs are shown) traced above the horizontal line passing through the center of the basic cylinder 62. Similarly, another plurality of additional circular arcs are shown traced below the horizontal line passing through the center of the basic cylinder 62 (again only four such arcs are shown). Tangents T to all these additional arcs delineate the flat-face extensions 66 on each side of cylindrical central portion 64. To state this in another way, each flat face 66 begins at initial tangent point t and extends parallel to the line (a or b) of movement of the radial center of cylindrical central portion 64 as the radial center moves along the great circle pitch circle of the external gear when the axes of the gears are intersecting at the maximum angle x°.

To facilitate understanding of the construction shown, extensions 66 continue a small distance beyond the minimal necessary length indicated by point e demarking the 2x° (60°) radial line. In this construction, the flat tooth end surfaces 68 have been rounded slightly, showing a design more amenable to the net forming manufacturing process.

(8) For the final construction, reference is made to FIG. 5D which is a partial and schematic view of internal gear 10 and external gear 20 taken in the radial center plane of the gears. The respective gear teeth, constructed in the manner just described above, are shown with the gears in full mesh when their respective axes are aligned at 180°. Three internal teeth 58 are shown in mesh with two external teeth 60. As indicated earlier, it can be seen that the working surfaces of all the teeth are straight-sided. External teeth 60 have a spline shape with a dimension determined by extension lines 56 from circle 58 that has a diameter equal in length to normal chordal thickness 54.

When the axes of the spherical gears of the invention are in 180° alignment, all of the teeth of gears 10 and 20 mesh together in the same manner as the teeth of a geared coupling. However, as indicated above, whenever the axes of spherical gears are positioned out of the 180° alignment, the gears are constantly moving into and out of mesh at each pole, i.e., their two shared meshing centers. In this regard, it should be understood that in preferred embodiments of spherical gears no backlash is required, although a tolerance is left between the teeth of the respective gears (e.g., 0.002″/0.05 mm) for manufacturing assembly and lubrication. Also, the top lands of the teeth are provided with spherical relief.

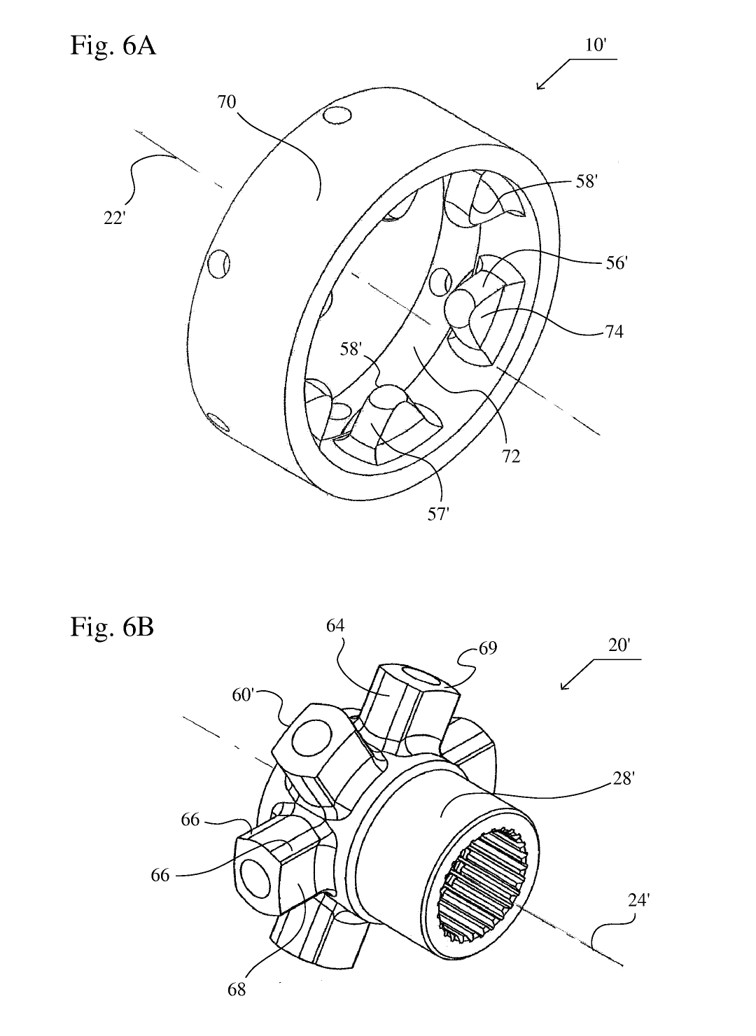

Perspective views of a pair of spherical gears are shown, respectively and separately, in FIGS. 6A and 6B. In this embodiment, internal gear 10′, in FIG. 6A, includes a basic support ring 70 having an internal surface from which each internal tooth 58′ extends perpendicular to axis 22′ of gear 10′. Ring 70 includes an indented rim 72 that is formed to matingly engage the outside of the cup support for the internal gear. (e.g., see cup 112′ in FIG. 11B) so that gear 10′ is fixed for rotation with the cup support. This view makes it easier to see the flat tooth end surfaces 74 that border the working surfaces of each cone-shaped tooth face 56′, 57′ of each internal tooth 58′ of this embodiment. While such flat end surfaces reduce weight, net forming manufacture may be facilitated, and additional strength may be achieved, by filling in the non-tooth face portions of each tooth to form a full, but partially hollowed-out, cone (see the preferred embodiment disclosed in FIGS. 1, 2, and 7).

In FIG. 6B, external teeth 60′ extend perpendicular to axis 24′ of external gear 20′ that is mounted, in this embodiment, in a ring about hub 28′ that includes a splined opening at one end for receiving a respective shaft (e.g., shaft 16 in FIG. 1). The other end of hub 28′ (not shown) is matingly fitted over the joint's centering ball (e.g., centering ball 26 in FIGS. 1 and 2). This perspective view makes it easier to see the cylindrical central portion 64 and the flat face extensions 66 that form the working tooth faces of each external tooth 60′. Again, as just mentioned above, flat end surfaces 68 can be rounded to facilitate manufacture. Also to be noted is the spherical relief of each top land 69 of the exterior gear.

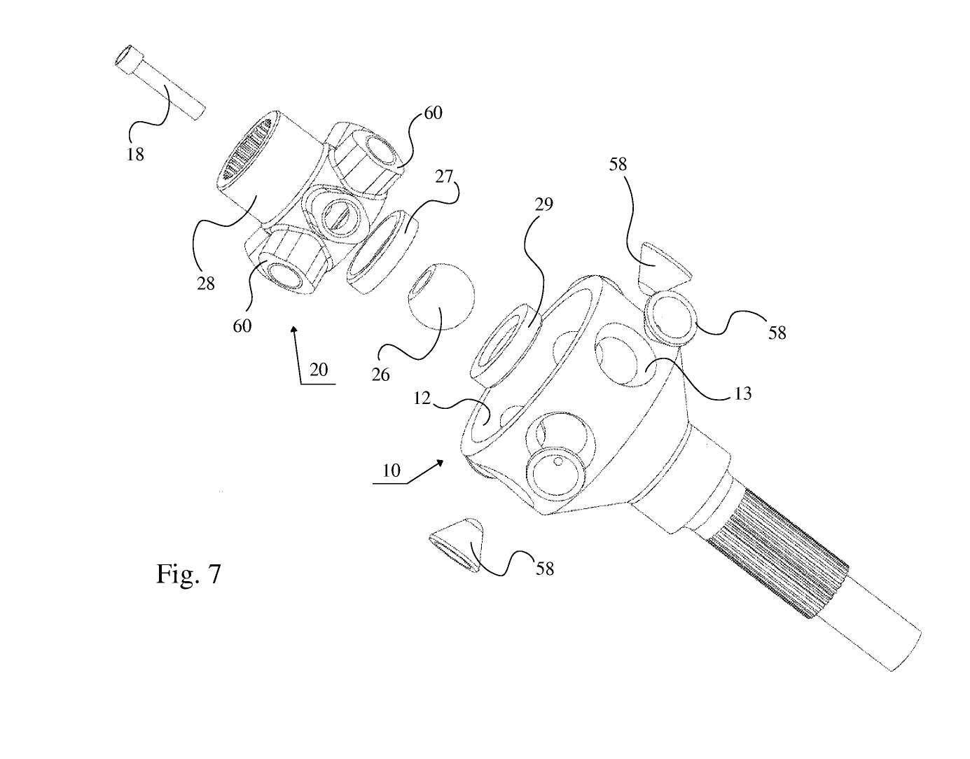

FIG. 7 shows an exploded view of the design of the invention's CV-joint illustrated in FIGS. 1 and 2. In this preferred embodiment, the teeth 58 of interior gear 10 are separately formed and press-fitted into pre-formed apertures 13 in the walls of support cup 12, while the hollow teeth 60 of exterior gear 20 are formed about the exterior of a hub 28. As indicated above, centering ball 26 is captured between spherical rings 27 and 29 that are held by a C-clip (not shown in this view) within hub 28. The CV-joint is held together by bolt 18 that tightens into the base of cup 12. Both internal teeth 58 and external teeth 60 are hollowed out to save metal and weight. Exterior teeth 60 may be formed integrally with the hub or in a separate ring that is press-fitted over the hub.

### Tooth Contact Pattern

The straight-sided tooth surfaces just described above create a relatively long line of contact throughout mesh during the entire continuum of angles of intersection. The length of this line contact is most easily seen in FIG. 5D which shows the contact at full mesh when the axes of the gears are in straight alignment. This line contact is quite long. For instance, in an actual joint designed according to the invention as disclosed, each smaller sphere 40 had a diameter of 0.75″ (19 mm), the pitch circles 42 of the gears were 2.625″ (67 mm), the centering ball 26 had a diameter of 0.9375″ (24 mm), and the length of the line contact was 0.4375″ (11 mm).

As the axes of the gears move out of alignment, the mesh quickly moves from all twelve teeth, and most of the load is carried primarily by four teeth. Namely, as explained above, as the axes of the spherical gears move out of alignment, the great-circle pitch circles of the gears intersect at two “poles” 180° apart (e.g., like circles of longitude on a globe of the earth intersecting at the north pole and south pole). Except for very small angles of intersection, most of the load is shared by two teeth on each gear that mesh at each pole position. However, there is sufficient overlap so that a smooth transition exists between successive sets of meshing internal and external teeth at each pole. That is, the tooth contact is rolling off the preceding pair of teeth as it rolls onto the succeeding pair.

As the angle of intersection increases, the length of line contact remains the same. The line contact patterns are illustrated in dark, heavy lines in the chart shown in FIG. 8 which shows the position of the lines of contact on the respective tooth faces of both the interior gear (I) and the exterior gear (E) at −30°, −18°, −12°, −6°, 0°, +6°, +12°, +18°, and +30° at the moment the teeth move through the pole position. As can be seen, the line contact remains vertical to the tooth face of the exterior gear at all times, but it tips away from the vertical on each interior cone-shaped tooth face. As the angle between the gears increases, the lines of contact roll through increasingly larger contact areas extending away from the respective centers of the gear faces. While the lines on each exterior gear face remain vertical to the gear face, the lines on the respective interior cone-shaped tooth face become more and more tipped to the vertical as they move away from the center of the cone-shaped tooth face. The lines shown in FIG. 8 indicate the outer extremity of the contact pattern at each angle of axial intersection, the gears rolling through contact from the center of the tooth faces to the positions shown.

When the line contacts are moving and tipping to the left on the respective tooth faces at one pole, they are moving and tipping to the right in exactly the same manner at the opposite pole. Since this last-mentioned fact may be difficult to understand, it is suggested that reference again be made to (a) FIGS. 3A, 3B, and 3C illustrating the relative motion between sets of tooth contact points on the theoretical spherical pitch surfaces of a pair of spherical gears rotating together in a clockwise direction, and to (b) FIGS. 9A and 9B showing the gears in contact near the respective poles when the axes of the gears intersect at the maximum angle x° from the horizontal (30° in the illustrated preferred embodiment), providing the full angular displacement of 2x° (60° shown). In FIGS. 9A and 9B it is assumed that the gears are rotating about their respective axes in the clockwise directions indicated and that external teeth 60 are driving internal teeth 58, the latter being viewed from the root circle of the internal gear. [Note: in FIGS. 9A and 9B, the cup-like support 12 for the teeth of internal gear 10 (FIGS. 1 and 2) is omitted for clarity.]

In FIG. 9A, a central external tooth 60 of external gear 20 is exactly aligned with one pole as tooth 60 rises from below the plane of internal gear 10, being shown just before the moment it moves out of contact with internal tooth 58. The position of this line of contact is indicated by arrow 76. FIG. 9B shows the same gear pair of FIG. 9A at the same instant in time, but viewed from the opposite pole. In FIG. 9B, a central external tooth 60 of external gear 20 is again exactly aligned with the opposite pole but, of course, is shown moving down from above the plane of internal gear 10, again being shown just before the moment it moves out of contact with internal tooth 58. The position of this latter line of contact is indicated by arrow 77.

In FIGS. 9A and 9B, a portion of the top land of each centrally positioned external tooth 60 is marked with thin cross hatching indicating alignment with the entire working face of the tooth. A series of dark straight lines appear on the lower half of the working face of external tooth 60 in FIG. 9A, and a similar series of straight lines appear on the upper half of the working face of external tooth 60 in FIG. 9B. These lines represent the series of line contacts shown earlier in FIG. 8, showing the contact pattern shared by the teeth as they roll through their respective meshing engagements at each pole. These respective contacts occur simultaneously on opposite halves of each tooth face, providing remarkable balance of both load and wear.

Although most of the load is shared by only two teeth in mesh at each pole, at least four teeth are in full mesh at all times, and the total load is always divided between at least two points separated by 180°. For instance, returning to the actual joint designed according to the invention as discussed above, the length of the line contact was 0.4375″ (11 mm). Therefore, it is important to remember that the total load is distributed over two lines totaling 0.875″ (22 mm). Also, the loads are balanced at all times on the gears as the teeth are meshing simultaneously at the two poles on opposite sides of both gears.

In another very important difference from the prior art spherical gearing discussed in the Background above, the teeth disclosed herein do not have sliding contact similar to hypoid gearing. Contrarily, the line contact just described above rolls through mesh at both poles. This very important feature facilitates lubrication and reduces wear.

### Double CV-joint

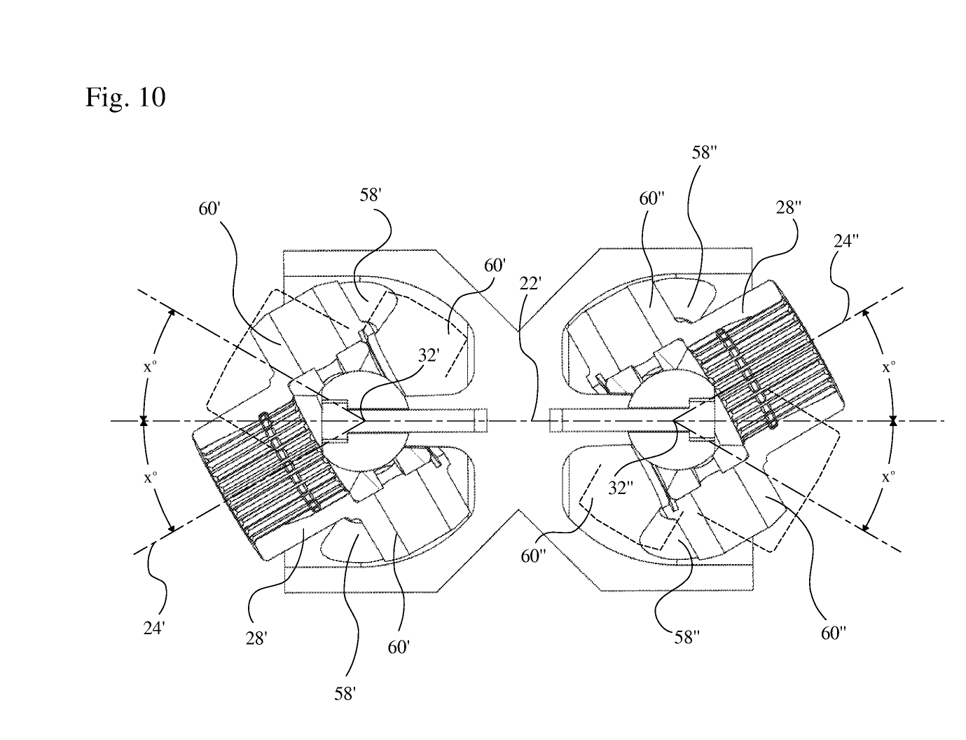

Segmental drive shafts, such as those common on large trucks, are generally connected with combinations of Cardan or Hooke universal joints. These prior art couplings are hard to maintain and are relatively short-lived. As indicated above, persons skilled in this art will immediately appreciate that by placing two of the invention's just-described spherical-gear joints back-to-back, like a double Cardan universal joint, constant velocity rotational motion can be transmitted by shafts intersecting throughout a continuous maximum range of 120° or more. Such an arrangement is shown in FIG. 10, connecting the ends of the first and second shafts positioned along the axes 24′ and 24″.

The external teeth 60′, 60″ are shown in solid lines pivoted about a pivot axis 32′, 32″. An external tooth 60′, 60″ is also shown in phantom lines pivoted about axis 32′, 32″ at an angle x° in the opposite direction, providing a full range of motion of 4x° (120° when x is 30) in all directions. Hubs 28′, 28″ and internal teeth 58′, 58″ are also shown in FIG. 10. In this embodiment, the first universal coupling is fixedly mounted to the second universal coupling through a first element. This provides a continuous range of motion of 4x° between a second element extending from the first universal coupling and a third element extending from the second universal coupling.

### Use in Automotive Half-Shaft

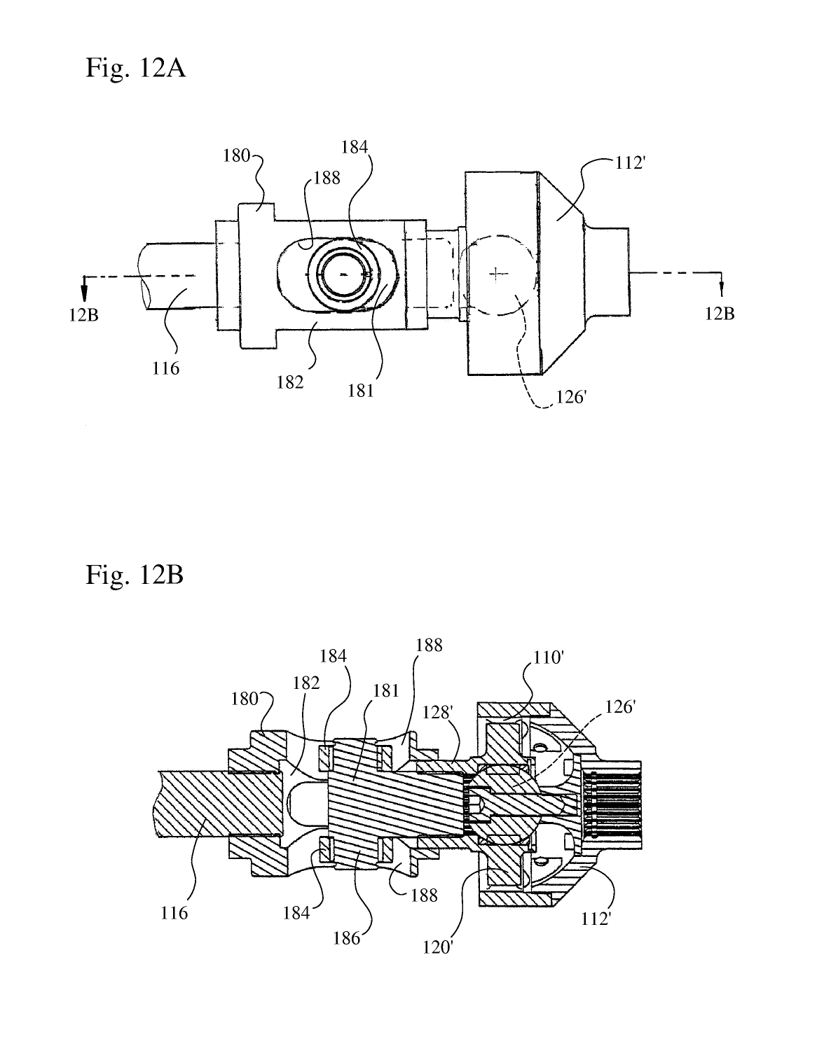

Reference is now made to FIGS. 11, 12A, and 12B. Two identical spherical-gear CV-joints according to the invention are positioned at the opposite ends of a half-shaft 100 schematically represented in FIG. 11 with the “boots” removed (i.e., without the well-known supple coverings used to protect the joints from road debris and dirt). In the manner explained in greater detail above, the respective cup-like supports 112, 112′ of each CV-joint have a respective centering ball 126, 126′ fixed to the base of the cup, and each CV-joint has a hub 128, 128′ that fits about each respective centering ball 126, 126′ for movement throughout a continuum of angular orientations from 0° to a predetermined maximum angle of x° in all directions. Each CV-joint also has an internal spherical gear (110′ in FIG. 12B) fixed within each cup-shaped support, and an external spherical gear (120′ in FIG. 12B) fixed to each hub (128′ in FIG. 12B). In the preferred embodiment shown, the hubs 128, 128′ of each CV-joint are, respectively, connected for rotation at each end of a shaft 116. The base of each cup-like support 112, 112′ has a splined opening for receiving the ends of respective connecting shafts 114, 114′.

The schematic illustration of FIG. 11 shows automotive half-shaft 100 at the end of a vehicular drive train that includes a differential 102 and a drive wheel 104. While not illustrated in this schematic illustration, it is assumed that drive wheel 104 is mounted on the front of a vehicle in a manner well known in the art so that drive wheel 104 has freedom of movement throughout a continuum of angular orientations relative to differential 102 that permit the drive wheel to turn for steering and to move up and down in response to terrain changes. Half-shaft 100 transfers constant velocity rotational forces from the vehicle engine through differential 102 to drive wheel 104 during all relative instantaneous angular movements occurring between these two portions of the vehicular drive train.

Those skilled in the art appreciate that as movably-mounted drive wheel 104 changes angular position relative to the fixed position of differential 102, the distance between them changes. While this change is not great (e.g., <1.0″/25 mm), it must be compensated, and this is accomplished by a slider 180 shown in larger scale in FIGS. 12A and 12B. Slider 180 includes two relatively movable members 181, 182, the first member 181 being mounted for reciprocation within the second member 182. Member 181 is fixed to hub 128′ and preferably has a pair of rollers 184 suspended from a cross arm 186. Rollers 184 ride in a pair of respective tracks 188 formed in exterior member 182 that is fixed, respectively, to shaft 116. In response to slight distance changes between drive wheel 104 and differential 102, slider 180 moves back and forth over rollers 184.

Half-shaft 100 has many significant advantages over present half-shafts:

(1) Half-shaft 100 has substantially identical couplings at both ends, thereby simplifying manufacture requiring fewer different parts for manufacture and replacement inventories.

(2) The number of parts in each spherical-gear CV-joint of the invention is fewer, and the parts are less complex and not as expensive to manufacture or assemble.

(3) Since the teeth of the spherical gears in the CV-joints of the invention are only in contact at the respective poles, the frictional resistance to rotation at all angles of orientation is remarkably less than that in present half-shafts, thus reducing the torque required to turn half-shaft 100 during changes of angular orientation, simplifying assembly and increasing drive train efficiency.

(4) Lubrication of half-shaft 100 is facilitated by the rolling motion of the spherical gear teeth as they move in and out of mesh twice in every revolution, and the relatively low friction of the mesh permits the use of less expensive lubricants.

The spherical gear designs described and claimed herein provide a significant improvement in the art of automotive CV-joints, universal couplings, and half-shafts.

Although a spherical gear of the present invention has been described as having a preferred predetermined maximum angle of 30°, a spherical gear may have a predetermined maximum angle of less than 30° or greater than 30° within the spirit of the present invention. Tooth shape changes as a function of the predetermined maximum angle, as shown in FIG. 5C and as described above.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A universal coupling for transmitting rotational forces between a first element and a second element, each said element being rotatable about a respective one of two axes variably intersecting over a continuous range from 180° to an angle differing from 180° by a predetermined maximum angle x° so that said elements intersect over a continuous maximum range of 2x°, said coupling comprising:
a single pair of gears including a first gear comprising a plurality of internal teeth and a second gear comprising a plurality of external teeth matingly meshing with said internal teeth, each gear being fixed to a respective one of said elements for rotation therewith;
each of said gears having a respective theoretical pitch surface in the form of a respective large pitch sphere, said large pitch spheres being concentric and having radii which are substantially identical, and each of said gears having a pitch circle that is, respectively, a great circle on one of said large pitch spheres so that said pitch circles effectively intersect with each other at two pole points separated by 180°;
each internal tooth having an internal tooth face being formed with a straight-sided profile having the shape of a portion of a cone;
each external tooth having an external tooth face being formed with a straight-sided profile having a cylindrical central portion with a predetermined radius and also having two flat face extensions of predetermined width formed, respectively, on each side of said cylindrical central portion; and
when said gears are rotating in a driving and driven relationship, said axes intersect at the center of said great pitch spheres throughout said continuous range of angles.

2. The universal coupling of claim 1, wherein x is at least 30.

3. The universal coupling of claim 1, wherein an internal portion of each said internal tooth and each said external tooth is hollowed.

4. The universal coupling of claim 1, wherein the universal coupling is fixedly mounted back-to-back to a second universal coupling substantially identical to said universal coupling to provide a continuous maximum range of motion of 4x° between one of said first and second elements and a third element extending from said second universal coupling.

5. The universal coupling of claim 1, wherein each respective tooth of both said gears is formed within one of a plurality of individual smaller theoretical spheres arranged in a circle so that each successive smaller sphere is tangent to the next smaller sphere at points of contact falling on the surface of said large pitch spheres, the distance between said points of contact on each smaller sphere defining the normal chordal thickness of each respective tooth.

6. The universal coupling of claim 5, wherein the surface of each said internal tooth face is tangent to its respective individual smaller sphere at said points of contact shared between said smaller spheres, and wherein the cone vertex angle of the portion of a conical surface of said internal tooth face is determined by a construct including a) said smaller theoretical spheres plus a further smaller theoretical sphere of equal size positioned centrally concentric to said two large theoretical spheres, and b) two crossing lines constructed tangent to opposite sides of said smaller central sphere and passing through a respective one of the two points of tangency that one of said smaller theoretical spheres shares with its neighboring spheres, said cone vertex angle being determined by an included angle formed at the point of intersection (c) by said intersecting lines.

7. The universal coupling of claim 6, wherein each internal tooth extends perpendicularly to the axis of said first element, and wherein each external tooth extends perpendicular to the axis of said second element.

8. The universal coupling of claim 5, wherein said predetermined width of said flat face extensions of each said external tooth face varies in accordance with said maximum angle x°, said extensions being formed to each side of a tooth face center from initial tangent points located x° from the center line of said tooth face center and extending at least to a radial line of said cylindrical central portion measuring 2x°, such that the length of each flat portion on each side of said tooth face center extends an additional x° beyond said tangent point of x°, and wherein each said flat face extension extends from said initial tangent points parallel to the line of movement of the radial center of said cylindrical central portion as said second gear moves along an elliptical arc relative to said first gear when the axes of the gears are intersecting at said maximum angle x°.

9. The universal coupling of claim 5, wherein said predetermined radius of the cylindrical central portion of each external tooth face is equal to one-half said normal chordal thickness of each respective external tooth.

10. The universal coupling of claim 5, wherein said plurality of individual smaller spheres is twelve in number such that each said gear has six teeth, and wherein the cone vertex angle of the cone shape portion of each internal tooth face is 60°.

11. The universal coupling of claim 10, wherein each said internal tooth is formed within a cup-like support fixed to an end of a first one of said rotatable elements, and further comprising a centering ball mounted within said cup-like support, said centering ball having a radius no greater than the distance between said concentric centers of said large pitch spheres and a point of intersection (c).

12. The universal coupling of claim 11, wherein each said external tooth is mounted on a hub portion attachable to an end of said second element and said hub portion is matingly fitted over said centering ball for angular movement in any direction from 180° up to the predetermined maximum angle x°.

13. The universal coupling of claim 12, wherein said internal and external teeth are in mesh simultaneously at each of said respective pole points separated by 180°.

14. The universal coupling of claim 13, wherein respective pairs of said internal and external teeth are successively in mesh so that a second one of said pairs enters mesh before the prior pair leaves mesh at all times at all angles as said elements variably intersect over said continuous range of angles.

15. The universal coupling of claim 13, wherein the contact pattern shared by said pairs of internal and external teeth in mesh is a full line contact throughout all said variable angles, said lines of contact moving across the full tooth faces of said respective gears as the angles of intersection vary throughout said continuous range.

16. Two universal couplings according to claim 15, comprising a first universal coupling and a second universal coupling, attached, respectively, to the ends of an automotive half-shaft.

17. The universal couplings of claim 16, wherein said hub portion of each said respective coupling is attached, respectively, to one end of said automotive half-shaft.

18. The universal couplings of claim 17, wherein the cup-like support of said first universal coupling is connectable to an automotive differential, and the cup-like support of said second universal coupling is connectable to an automotive drive wheel.

19. The universal couplings of claim 16 further comprising a slider positioned intermediate said universal couplings, the overall length of said slider changing to compensate for the differing distances between said drive wheel and said differential due to the relative movement of said drive wheel.

20. The universal couplings of claim 19, wherein said slider comprises a first member having at least one roller and a second member having a track for matingly receiving said roller, whereby the movement of said slider along said roller changes the overall length of said slider to compensate for the differing distances between said drive wheel and said differential due to the relative movement of said drive wheel.

21. The universal coupling of claim 1, wherein each said internal tooth is formed within a cup-like support fixed to an end of said first element.

22. The universal coupling of claim 21, wherein each said internal tooth is individually formed and press-fitted into said cup-like support.

23. The universal coupling of claim 21, wherein a centering ball is mounted in said cup-like support.

24. The universal coupling of claim 21, wherein each said external tooth is mounted on a hub attachable to an end of said second element.

25. The universal coupling of claim 24, wherein said hub is matingly fitted over said centering ball for angular movement in any direction from 180° up to the predetermined maximum angle x°.

26. An automotive half-shaft for interconnecting a rotatable input with a drive wheel that is mounted for instantaneous angular movements relative to said input, said half-shaft comprising:
a pair of substantially identical universal couplings, each coupling comprising a centering ball fixed within a cup-shaped support and a hub matingly engaged with said centering ball so that the hub is free to move throughout a continuum of angular orientations from 0° to a maximum angle of x° in all directions;
an internal spherical gear fixed within each cup-shaped support, and an external spherical gear fixed to each hub;
the hub of each coupling being connected for rotation with, respectively, a respective end of said half-shaft;
the cup-shaped support of one coupling being connectable to the rotatable input, and the cup-shaped support of the other coupling being connectable to the drive wheel; and
a slider positioned intermediate the two couplings to compensate for the differing distances between the drive wheel and the rotatable input due to the relative movement of the drive wheel.

27. The half-shaft of claim 26, wherein the slider comprises a first member having at least one roller and a second member having a track for matingly receiving the roller, whereby the movement of the slider along the roller changes the overall length of the slider to compensate for the relative movements of the drive wheel.

28. The half-shaft of claim 26, wherein one of the members of the slider is fixed to the hub of one of the couplings.

29. A pair of gears for transmitting rotational forces between a first element and a second element, each said element being rotatable about a respective one of two axes variably intersecting over a continuous range from 180° to an angle differing from 180° by a predetermined maximum angle x° so that said elements intersect over a continuous maximum range of 2x°, said gear pair comprising:
a first gear comprising a plurality of internal teeth and a second gear comprising a plurality of external teeth matingly meshing with said internal teeth, each gear being attachable to a respective one of said elements for rotation therewith;
each of said gears having a respective theoretical pitch surface in the form of a respective large pitch sphere, said large pitch spheres being concentric and having radii which are substantially identical, and each of said gears having a pitch circle that is, respectively, a great circle on one of said large pitch spheres so that said pitch circles effectively intersect with each other at two pole points separated by 180°;
each respective tooth of both said gears being formed within one of a plurality of individual smaller theoretical spheres arranged in a circle so that each successive smaller sphere is tangent to the next smaller sphere at points of contact falling on the surface of said large pitch spheres, the distance between said points of contact on each smaller sphere defining the normal chordal thickness of each respective tooth;
each internal tooth having an internal tooth face being formed with a straight-sided profile having the shape of a portion of a cone;
each external tooth having an external tooth face being formed with a straight-sided profile having a cylindrical central portion with a radius equal to said normal chordal thickness; and
when said gears are rotating in a driving and driven relationship, said axes intersect at the center of said great pitch spheres throughout said continuous range of angles.

30. The gears of claim 29, wherein each said external tooth face has two flat face extensions of predetermined width formed, respectively, on each side of said cylindrical central portion.
